(19) United States
(12) Patent Application Publication
(10) Pub. No.: US 2008/0193639 A1
(43) Pub. Date: Aug. 14, 2008

(54) Method for making direct marketing composite materials and barcode for composite materials

(75) Inventors: Matthew Thomas Adams, Mason, OH (US); Glenn David Aspenns, Cincinnati, OH (US)

Correspondence Address: SEED INTELLECTUAL PROPERTY LAW GROUP PLLC, 701 FIFTH AVENUE, SUITE 5400, SEATTLE, WA, 98104-7092, US

(73) Assignee: Intermec IP Corp., Woodland Hills, CA (US)

(21) Appl. No.: 11/894,583

(22) Filed: Aug. 20, 2007

Related U.S. Application Data
(62) Division of application No. 10/622,559, filed on Jul. 18, 2003, now abandoned.
(60) Provisional application No. 60/397,457, filed on Jul. 18, 2002.

(51) Int. Cl. B05D 5/00; B29C 70/70; B42D 15/00

(52) U.S. Cl. 427/130; 264/132

(57) ABSTRACT

A label marks a composite material. In one embodiment, the label may be printed with magnetically doped ink and may be embedded between layers of the composite during manufacture. In one embodiment, the label may be embedded on the surface of the composite material using a heat curable resin. In one embodiment, the label carries indicia that may be read with magnetic ink character recognition (MICR) or other magnetic scanning technology. In one embodiment, there is no need for visual contrast between the composite, label and/or indicia.

### CROSS-REFERENCE TO RELATED APPLICATION

This application is a division of U.S. patent application Ser. No. 10/622,559, filed Jul. 18, 2003, now pending; which claims the benefit under 35 U.S.C. 119(e) of U.S. Provisional Application No. 60/397,457, filed Jul. 18, 2002; both of which are incorporated herein in their entirety.

### BACKGROUND

1. Technical Field

The present disclosure relates to embedded labels and bar codes. Specifically, it relates to embedded labels and bar codes for composite materials using mesh material printed with magnetically doped ink.

2. Description of Related Art

Using a data carrier for direct marking of parts made from composite materials such as Kevlar, fiberglass, carbon fiber, etc. is difficult for several reasons. First, the data carrier must be very thin and porous to avoid affecting the functionality of the part to be marked. Second, the data carrier must be relatively simple to use. Third, in many applications the color of the embedded data carrier must blend into the color of the part. Light colored carriers or indicia are not desirable on a dark composite for these applications. Further, high contrast between the indicia and/or carrier and the composite is not desired.

There is a need to eliminate the problems that existing data carriers have with these issues.

One prior art method of making composites is to embed printed fabric into light colored composite materials as a means of marking them for identification purposes. This process involves the encapsulation of a white typewriter-printed fabric within a heat-curable resin on the surface of the item being marked. This method of marking items requires a visible marker, something that is undesirable in some applications. Further, because the method requires a visible marker it does not provide a means of marking dark-colored composite materials such as graphite, Kevlar, and carbon fiber.

### BRIEF SUMMARY

Embodiments herein disclose a way of creating a magnetic image that is decoded by a magnetic scanning device. Technology has been developed that is capable of decoding machine-readable indicia, codes, and/or symbols that are magnetically charged, even through non-metallic visual obstructions. This technology is used for the marking of parts that include composite materials using an embedding process.

There is a need for a way of directly marking dark colored composite materials. Accordingly, in one embodiment, a method of direct marking of dark colored composite materials, such as Kevlar, fiberglass, and carbon fiber is provided.

There is also a need for a way of marking composite materials for identification that will not affect the functionality of the part. Accordingly, in another embodiment, a method of marking composite material that does not affect the functionality of the part and which is simple to use is provided.

There is a need for a means of marking composite materials for identification in which the identifying marker is hidden or invisible. This is useful for security, national defense, or other similar uses. Accordingly, in one embodiment, a method of marking composite materials for identification in which the marker is hidden or invisible is provided.

### BRIEF DESCRIPTION OF THE SEVERAL VIEWS OF THE DRAWINGS

FIG. 1 shows an exploded side view of a composite material embedding a data carrier, according to one non-limiting illustrated embodiment.

FIG. 2 shows an exploded side view of a composite material, a data carrier, and a resin material, according to one non-limiting illustrated embodiment.

FIG. 3 shows a cut-away view of a container having a data carrier disposed on an inner surface of the container, according to one non-limiting illustrated embodiment.

FIG. 4 shows a cut-away view of a container having an object disposed inside of the container, according to one non-limiting illustrated embodiment.

### DETAILED DESCRIPTION

Magnetic ink character recognition (MICR), uses a reader that can discern characters printed onto non-magnetic materials using magnetic ink in much the same manner as optical character recognition (OCR) scanners use contrast between a medium and an image printed on the medium such as a black image printed on a white paper. MICR is used to print the account numbers on the bottom of checks to make them easily scanned. Similar magnetic imaging technology will allow persons to scan machine-readable bar codes. This ability to use non-optical means for identification solves issues related to marking dark-colored composite materials. Because the scanners read the magnetized ink there is no need for any visual contrast between the ink, carrier and/or object. On dark colored composites, a dark colored carrier with dark indicia is often preferred to minimize or eliminate any visible marks indicating a label.

In one non-limiting embodiment, a mesh such as a porous woven mesh may be printed with ink that has magnetic components incorporated into it. These magnetic components are visible to the scanners, in much the same way as a MICR scanner scans the account numbers on checks. The mesh works for embedding because it is thin and porous, allowing surrounding composite material to flow into the pores and bond with the mesh.

Composite materials are typically formed from at least one reinforcing material and a matrix. The reinforcing material may be, for example, fiber, particulate, or a laminate. Matrix materials may be, for example, ceramic or polymers. Through the selection of variables such as reinforcing material(s), matrix material, composition and reinforcement arrangement composites with a wide range of properties have been developed. Common composite materials are glass-polymer, graphite-polymer, kevlar-epoxy, kevlar-polyester and carbon-carbon composites. Polymer and ceramic matrix composites are widely used, for example, in automotive, marine, aircraft, and aerospace components. They are also used in sporting goods, such as tennis rackets, skis, and fishing rods.

In one non-limiting embodiment, a magnetic ink may be used in marking a composite material. Because the ink is easily magnetizeable it is preferable that the composite be made of a non-magnetic matrix and non-magnetic reinforcement material.

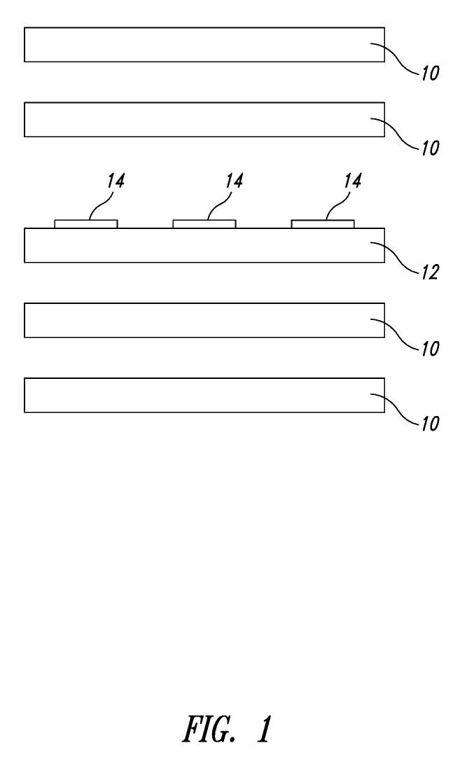

Referring to FIG. 1, a composite material with an embedded barcode is shown. The composite material consists of a plurality of layers of composite material 10. Sandwiched between two of the layers of composite material 10 is a data carrier 12. Indicia 14 may be printed on one surface of the data carrier 12. In one non-limiting embodiment, the printed indicia 14 may be printed using magnetically doped ink. In some embodiments, the data carrier 12 may be a mesh. In some embodiments, the data carrier 12 may be a porous woven mesh. In some embodiments, the data carrier 12 may be a porous woven mesh that is very thin and porous. A porous woven mesh allows the matrix material of the composite material 10 to flow into the pores of the mesh thus bonding the wet mesh with the composite material 10.

In some embodiments, the data carrier 12 may be printed with the appropriate indicia 14. The indicia 14 may be any suitable text, a symbol, bar code or other indication. In some embodiments, the indicia 14 may be a bar code. The indicia 14 may be printed using an ink that has magnetic characteristics. In one preferred embodiment, the indicia 14 may be printed with magnetically doped ink. In some embodiments, the indicia need not have any visible contrast with the mesh and/or composite.

In some embodiments, the data carrier 12 is embedded between layers of composite material 10. Typically, a product made of composite material 10 such as Kevlar, carbon fiber and fiberglass is manufactured by laminating a plurality of layers of the composite material 10 together. The data carrier 12 is sandwiched between layers of composite material 10. The data carrier 12 is embedded between the layers of a composite material 10 during construction of a product. When the indicia 14 is printed using a magnetic ink and construction of the composite material is completed, a scanner using MICR or similar technology is able to read the indicia 14 through the composite material 10. Since the scanner only discerns the magnetic ink, the multiple layers of composite material 10 between the scanner and the data carrier 12 appear invisible to the scanner. Furthermore, the embedded data carrier 12 will not result in any visually discernable marks, effectively concealing the data and its location.

By way of one example, the nose cone of a jet aircraft is manufactured from carbon fiber that is black in color. The cone is manufactured by laminating many sheets of carbon fiber on top of one another resulting in a cone with extremely high strength properties. A data carrier 12 such as a porous woven mesh may be printed with an identification marker using magnetically doped ink. During construction of the cone, the printed data carrier 12 may be placed between two of the carbon fiber sheets used to construct the cone. The printed mesh, located between two of the carbon fiber sheets, is constructed into the cone. The marker is read through the cone.

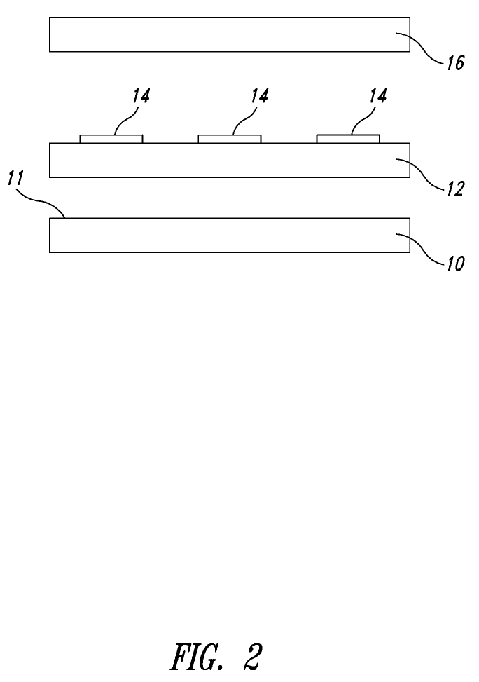

Referring to FIG. 2, a printed data carrier 12 may be embedded in or on the surface 11 of the composite 10 using a resin material 16, according to one non-limiting embodiment. The composite material 10 can be particulate, laminar, chopped fiber, unidirectional or other known composite type. The resin material 16 may be selected based on the composite. In one embodiment, the resin material 16 may be a heat-curable resin. In one embodiment, the data carrier 12 with printed indicia 14 may be placed on the surface 11 of the composite 10 during the manufacturing process, and the data carrier 12 may be coated with the resin material 16. In one embodiment, the data carrier 12 may be placed on the surface 11 of the composite material 10, after the composite material 10 has been manufactured. In that case, the resin 16 may be applied to coat the data carrier 12.

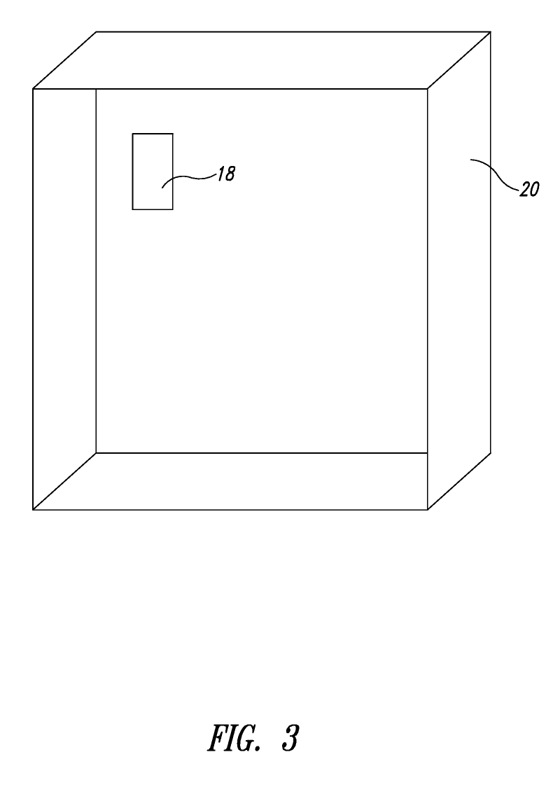

Referring now to FIG. 3, a container 20 is shown in cutaway, and a printed label 18 is disposed on an inner surface of the container 20, according to one non-limiting embodiment. The printed label 18 may be printed using ink with magnetic characteristics, such as, magnetically doped ink. The printed label 18 may be placed on the inside of the container 20 and sealed within the container 20. The printed label 18 may include indicia, which might or might not any visual contrast with the label 18. It may be desirable in some situations to have visual contrast, so that the label can be read using other methods such as by a person or OCR scanner once the container 20 is opened or before it is closed.

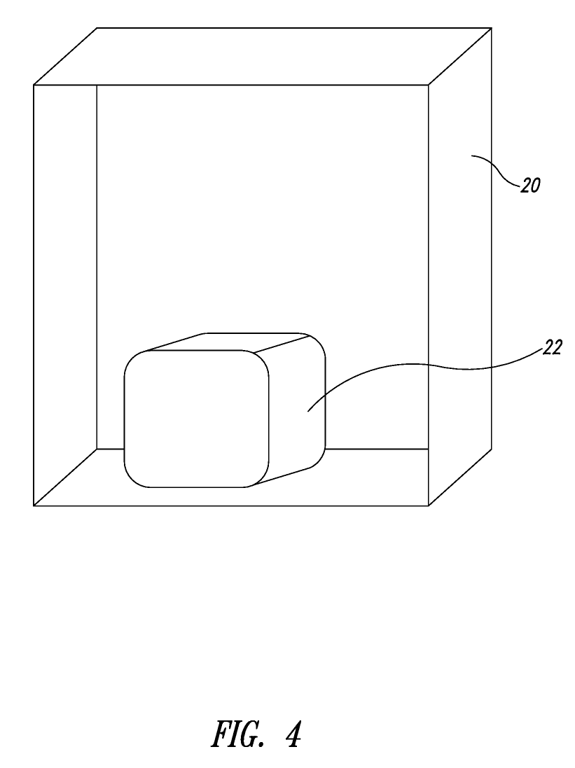

In FIG. 4, a cutaway view of a container 20 is shown according to one non-limiting embodiment. In the embodiment of FIG. 4, a composite object 22 such as an automotive, aerospace, marine, or aircraft part is disposed inside of the container 20. The object 22 includes an integral label (not shown). The label may be read through the container 22 wall.

1. A method of marking a composite article of manufacture, comprising:
printing a plurality of machine-readable symbol characters on a porous material with a magnetic ink, the machine-readable symbol characters are from at least a first machine-readable symbology;
interposing the printed porous material between a first layer of reinforcing material and a second layer of reinforcing material; and
binding the printed porous material between the first layer of reinforcing material and the second layer of reinforcing material with a resin material to form a composite material.

2. The method of claim 1, further comprising:
manufacturing the composite material into the composite article of manufacture.

3. The method of claim 1 wherein binding the printed porous material between the first layer of reinforcing material and the second layer of reinforcing material with a resin material to form a composite material includes:
coating the printed porous material with the resin such that the resin material flows into pores of the porous material.

4. The method of claim 1 wherein printing a plurality of machine-readable symbol characters on a porous material with a magnetic ink includes printing a plurality of machine-readable symbol characters from a barcode symbology.

5. The method of claim 1 wherein printing a plurality of machine-readable symbol characters on a porous material with a magnetic ink includes printing a plurality of machine-readable symbol characters from a magnetic ink character recognition symbology.

6. The method of claim 1, further comprising:
selecting the first layer of reinforcing material from a class of non-magnetic materials.

7. The method of claim 1, further comprising:
selecting the resin material from a class of non-magnetic materials.

8. The method of claim 1, further comprising:
selecting the porous material from a class of non-magnetic materials.

9. The method of claim 1, further comprising:
selecting the porous material and the composite material to have no visually discernable contrast between the porous material and at least one layer of the composite material.

10. The method of claim 9, further comprising:
selecting the porous material and the magnetic ink to no visually discernable contrast between the magnetic ink and the porous material.

11. A method of marking a composite article of manufacture, comprising:
obtaining a magnetic ink having a first color;
obtaining a porous material having a first surface having a second color;
printing a plurality of machine-readable symbol characters on the first surface of the porous material with the magnetic ink, the machine-readable symbol characters are from at least a first machine-readable symbology, wherein the first color and the second color are selected to minimize visual observation of the printed machine-readable symbol characters on the first surface of the porous material; and
binding the printed porous material with a resin material to a surface of a composite material.

12. The method of claim 11 wherein binding the printed porous material with a resin material to a surface of a composite material includes:
applying the printed porous material to the surface of the composite material; and
coating the printed porous material with the resin such that the resin material flows into pores of the porous material.

13. The method of claim 11 wherein printing a plurality of machine-readable symbol characters on the first surface of the porous material with the magnetic ink includes printing a plurality of machine-readable symbol characters from a barcode symbology.

14. The method of claim 11 wherein printing a plurality of machine-readable symbol characters on the first surface of the porous material with the magnetic ink includes printing a plurality of machine-readable symbol characters from a magnetic ink character recognition symbology.

15. The method of claim 11, further comprising:
selecting the resin material from a class of non-magnetic materials.

16. The method of claim 11, further comprising:
selecting the porous material from a class of non-magnetic materials.

17. The method of claim 11, further comprising:
obtaining the composite material, wherein the surface of the composite material has a third color, wherein the first color, the second color and the third color are selected to minimize visual observation of the indicia printed on the first surface of the porous material.
